(19) United States
(12) Patent Application Publication
(10) Pub. No.: US 2022/0159416 A1
(43) Pub. Date: May 19, 2022

(54) DYNAMIC MBMS/UNICAST BEARER ESTABLISHMENT BASED ON A MBMS MULTI-LEVEL BEARER QUALITY INDICATOR

(71) Applicant: Telefonaktiebolaget LM Ericsson (publ), Stockholm (SE)

(72) Inventors: John Camilo Solano Arenas, Neuss (DE); Joakim Åkesson, Landvetter (SE)

(21) Appl. No.: 17/432,023

(22) PCT Filed: Feb. 18, 2020
(86) PCT No.: PCT/EP2020/054190

§ 371 Date: Aug. 18, 2021

Related U.S. Application Data
(60) Provisional application No. 62/806,940, filed on Feb. 18, 2019.

(51) Int. Cl. H04W 4/06; H04W 4/90

(52) U.S. Cl. CPC H04W 4/06; H04W 4/90

(57) ABSTRACT

A method performed by a wireless device comprising a MC service client comprises: receiving media for a MC service over a first MBMS bearer, while located in a first MBSFN area; sending to a server a report that the media is successfully received over the first MBMS bearer, and including a first MBMS bearer quality indicator; sending a report to the server indicating that the wireless device is now located in an overlapping area between the first MBSFN area and a second MBSFN area; receiving a MBMS bearer announcement with information relating to the second MBMS bearer indicating that the first and second MBMS bearers transmit the same media; and sending to the server a report that media can be successfully received over the first and second MBMS bearers, and including a second MBMS bearer quality indicator that indicates reception quality levels related to the first and second MBMS bearers.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Mission Critical (MC) communication services are essential for the work performed by public safety users e.g. police and fire brigade. The MC communications service requires preferential handling compared to normal telecommunication services including handling of prioritized MC calls for emergency and imminent threats. Furthermore, the MC communication service requires several resilience features that provide a guaranteed service level even if part of the network or backhaul infrastructure fails.

The most commonly used communication method for public safety users is Group Communication (GC) which requires that the same information is delivered to multiple users. One type of Group Communication is Mission Critical Push to Talk (MCPTT) service. A Group Communication system can be designed with a centralized architecture approach, in which a centralized GC control node provides full control of all group data e.g. group membership, policies, user authorities and prioritizations. Such approach requires a network infrastructure that provides high network availability. This type of operation is sometimes known as Trunked Mode Operation (TMO) or on-network operation.

Furthermore, GC can be provided by utilizing different transmissions mode. One important aspect in GC is that the same information is delivered to multiple users. These users may be located at different locations. If many users are located within the same area multicast or broadcast based transmission using e.g. Multicast-Broadcast Multimedia Services (MBMS) is efficient. MBMS can be used in a transmission mode known as Multicast-broadcast single-frequency network (MBSFN). In MBSFN transmission MBMS bearers are established. Hence, there are several radio cells that transmit the same signal synchronously on the same frequency, which gives an improved Signal Interference and Noise Ratio (SINR), thanks to multiple transmissions added to a combined signal power and also considerable interference reductions for the wireless device.

Within the context of a Third Generation Partnership Project (3GPP) -based Long Term Evolution (LTE) network, the user equipments (UEs) get access to the radio access network (RAN) via radio base stations (i.e. eNBs). The eNBs are connected to an evolved packet core network (EPC) supporting MBMS. A GC server or MC service server is connected to the EPC. The RAN is then assumed to be configured with a set of pre-defined MBSFN areas. Hence, several eNBs are configured to be part of a same MBSFN area with a certain downlink capacity. There are also cases wherein an eNB doesn't belong to an MBSFN area or an UE is located outside an MBSFN area. For those cases, the MC service is provided by normal unicast transmission mode. It is then highly desirable to provide service continuity to the UEs.

The currently available solution for MC service continuity is standardized in 3GPP Technical Specification (TS) 23.280 V16.1.0 and 3GPP TS 23.468 V15.0.0. The standardized service continuity method relies on the methodology to transfer the group communication from multicast to unicast, from unicast to multicast, and from multicast to multicast. The transfer decision is based on a MBMS listening status report (defined in 3GPP TS 23.280), where an UE reports to the MC service server the transfer quality of the MBMS bearer. For instance, a UE moving from one MBSFN Area with no sufficient MBMS bearer quality will need to transfer the communication from multicast (e.g. in MBSFN Area 1) to unicast, or to another multicast (for example to another MBSFN Area, e.g. MBSFN Area 2) where the MC service is also being broadcasted on a sufficient MBMS bearer quality. If a UE is receiving data in unicast and moves into a MBSFN area, a communication transfer from unicast to multicast may then be performed.

### SUMMARY

Embodiments of the present disclosure are described within the context of a 3GPP-based LTE network. However, the problems and solutions described herein are equally applicable to wireless access networks and UEs implementing other access technologies and standards (e.g. a 5G system including 5G core and 5G radio access). LTE is used as an example technology where the invention is suitable and using LTE in the description therefore is particularly useful for understanding the problem and solutions solving the problem.

There currently exist certain challenge(s). In 3GPP TS 23.280, the MBMS listening status report is based basically on a binary status, i.e. it indicates if the MBMS bearer quality is sufficient for transmission or not. However, interruption of a MC service may occur when the MC service server receives too late a report including a bad MBMS bearer quality. Therefore, this may lead to a late switching decision to change from a MBMS bearer to a unicast bearer or another MBMS bearer. Furthermore, MBSFN areas are pre-configured, where MBMS bearers may be continuously activated regardless if they are to be immediately used or not. However, this does not provide efficient resource utilization. On the other hand, if there is a configured MBSFN area that does not have activated MBMS bearers transmitting all expected MC services, with current MBMS listening status report, a MC service server may not have enough time to establish/activate a required MBMS bearer if a UE is potentially moving into the corresponding MBSFN area. As a result, there may be a service interruption.

Certain aspects of the present disclosure and their embodiments may provide solutions to the aforementioned or other challenges. As an efficient resource utilization technique, it is better to assume that the MBSFN areas do not activate MBMS bearers transmitting MC services that are not being used. Hence, and also considering that MBSFN areas are usually configured to be partially overlapping, i.e. some transmitting radio cells belong to one or more MBSFN areas, the proposed solution defines a procedure for the MC service server to dynamically establish or activate a required MBMS bearer in a second MBSFN area into which a UE is moving. Therefore, a UE moving from a first MBSFN area to a second MBSFN area is able to simultaneously receive the MC service from two different MBMS bearers belonging to the two different MBSFN areas. This procedure is based on a MBMS multi-level bearer quality indicator to be included in the MBMS listening status report as well as the location report which are sent by the UEs. Furthermore, based on the MBMS multi-level bearer quality indicator the MC service server can make an earlier and more efficient decision to switch from multicast to unicast, or to another multicast (for the case that a second MBSFN area has already an activate MBMS bearer transmitting the required MC service).

One embodiment of the present solution is directed to A method performed by a wireless device comprising a Mission Critical, MC, service client to enable reception of transmissions for a MC service, the method comprises the steps of: receiving MC service media for a MC service over a first Multicast-Broadcast Multimedia Service, MBMS, bearer identified by a first Temporary Mobile Group Identity, TMGI, while the wireless device is located in a first Multicast-Broadcast Single Frequency Network, MBSFN, area ; sending to a MC service server a first MBMS listening status report notifying the MC service server that the MC service media is successfully received over the first MBMS bearer, and including a first MBMS bearer quality indicator that indicates a reception quality level related to the first MBMS bearer; sending a location information report to the MC service server indicating that the wireless device is now located in an overlapping area between the first MBSFN area and a second MBSFN area, in which overlapping area both the first MBMS bearer and a second MBMS bearer identified by a second TMGI are active; receiving a MBMS bearer announcement with information relating to the second MBMS bearer indicating to the wireless device that the first MBMS bearer and the second MBMS bearer transmit the same MC service media; and sending to the MC service server a second MBMS listening status report notifying the MC service server that MC service media can be successfully received over the first MBMS bearer and the second MBMS bearer, and including a second MBMS bearer quality indicator that indicates a reception quality level related to the first MBMS bearer and a reception quality level related to the second MBMS bearer;

Another embodiment of the present solution is directed to A method performed by node to implement a Mission Critical service server, the method comprises the steps of: receiving from a wireless device while it is located in a first Multicast-Broadcast Single Frequency Network, MBSFN, area, a first MBMS listening status report notifying the MC service server that MC service media is successfully received over a first MBMS bearer identified by a first Temporary Mobile Group Identity, TMGI, and including a first MBMS bearer quality indicator that indicates a reception quality level related to the first MBMS bearer; receiving from the wireless device, a location information report indicating that the wireless device is now located in an overlapping area between the first MBSFN area and a second MBSFN area, in which overlapping area both the first MBMS bearer and a second MBMS bearer identified by a second TMGI are active; sending to the wireless device, a MBMS bearer announcement with information relating to the second MBMS bearer indicating to the wireless device that the first MBMS bearer and the second MBMS bearer transmit the same MC service media; and receiving from the wireless device, a second MBMS listening status report notifying the MC service server that MC service media can be successfully received over the first MBMS bearer and the second MBMS bearer, and including a second MBMS bearer quality indicator that indicates a reception quality level related to the first MBMS bearer and a reception quality level related to the second MBMS bearer; In some embodiments, systems and methods are provided for efficiently and proactively deciding when to establish a new GC session via an already established MBMS bearer in another MBSFN area, or when to establish a new multicast or unicast bearer based on a MBMS multi-level bearer quality indicator.

Thus, there are, proposed herein, various embodiments which address one or more of the issues disclosed herein.

Certain embodiments may provide one or more of the following technical advantage(s):
A MBMS bearer is dynamically and efficiently being established in a MBSFN area only when it has been identified that it will be used
A UE can efficiently be switched from a multicast bearer to another multicast bearer instead of being switched to a unicast bearer. Hence, a UE can be provided with a higher successful probability of a service continuity process by combining the information received from two MBSFN areas
A MBMS multi-level bearer quality indicator can be used to make an efficient and early switching decision from multicast to unicast, or to another multicast.

### BRIEF DESCRIPTION OF THE DRAWINGS

The proposed solutions are now described, by way of example, with reference to the accompanying drawings, in which:

FIG. 1 illustrates one example of a cellular communications network 100 in which embodiments of the present disclosure may be implemented;

FIG. 2 illustrates one example implementation of the cellular communications system 100 of FIG. 1;

FIGS. 3-4 illustrate overlapping MBSFN service areas;

FIG. 5 illustrates a dynamic establishment procedure of a new group communication session via an already established MBMS bearer;

FIG. 6 illustrates a dynamic MBMS/Unicast bearer establishment procedure due to no sufficient capacity in an MBSFN area;

FIG. 7 is a schematic block diagram of a node 700 implementing a GC server or a MC service server according to some embodiments of the present disclosure;

FIG. 8 is a schematic block diagram that illustrates a virtualized embodiment of a GC server or MC service server according to some embodiments of the present disclosure;

FIG. 9 is a schematic block diagram of the node 700 according to some other embodiments of the present disclosure;

FIG. 10 is a schematic block diagram of a UE 1000 according to some embodiments of the present disclosure;

FIG. 11 is a schematic block diagram of the UE 1000 according to some other embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in the document(s) provided in the Appendix.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

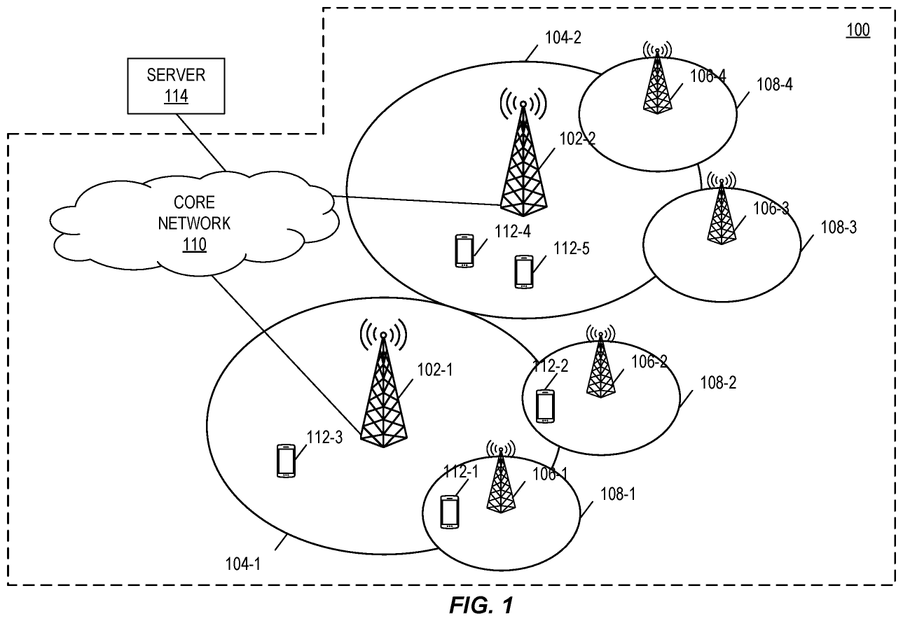

### FIG. 1

FIG. 1 illustrates one example of a cellular communications network 100 in which embodiments of the present disclosure may be implemented. In the embodiments described herein, the cellular communications network 100 is a LTE network; however, the present disclosure is not limited thereto. In this example, the cellular communications network 100 includes base stations 102-1 and 102-2, which in LTE are referred to as eNBs, controlling corresponding macro cells 104-1 and 104-2. The base stations 102-1 and 102-2 are generally referred to herein collectively as base stations 102 and individually as base station 102. Likewise, the macro cells 104-1 and 104-2 are generally referred to herein collectively as macro cells 104 and individually as macro cell 104. The cellular communications network 100 may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The base stations 102 (and optionally the low power nodes 106) are connected to a core network 110.

The base stations 102 and the low power nodes 106 provide service to wireless devices 112-1 through 112-5 in the corresponding cells 104 and 108. The wireless devices 112-1 through 112-5 are generally referred to herein collectively as wireless devices 112 and individually as wireless device 112. The wireless devices 112 are also sometimes referred to herein as UEs.

As illustrated, the cellular communications system 100 is associated with server 114. According to some aspects, the server 114 comprises a Group Communication Service Application Server (GCS AS), according to 3GPP TS 23.468 V15.0.0.

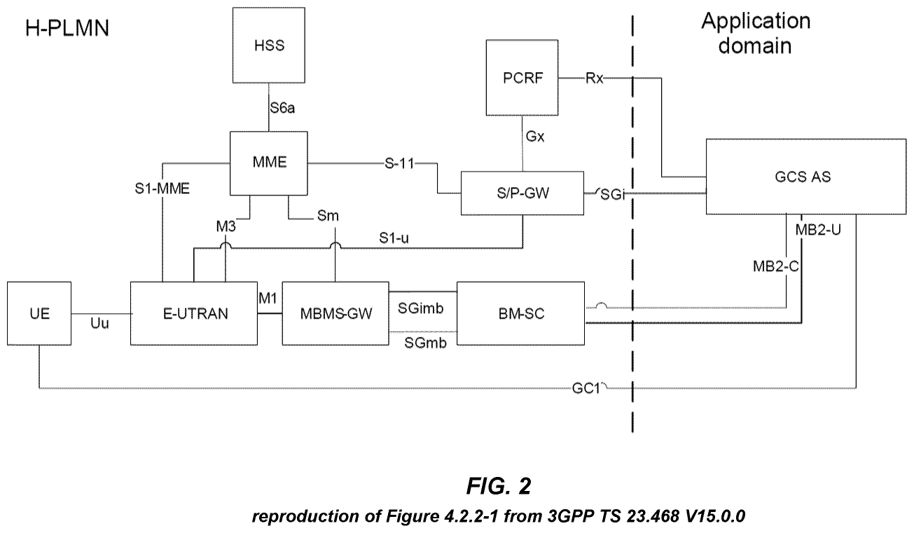

### FIG. 2

Embodiments of the present disclosure may generally relate to Group Communication Service Enabler (GCSE), which may be applied for mission critical (MC) communication/public safety in LTE networks, as specified in 3GPP TS 23.468 V15.0.0. In this regard, FIG. 2 illustrates one example implementation of the cellular communications system 100 of FIG. 1 in which the cellular communications system 100 is an LTE/E-UTRAN system, and the server 114 is server comprising a Group Communication Service (GCS) Application Server (AS), which is denoted GSC AS, as defined in 3GPP TS 23.468 V15.0.0, in accordance with some embodiments of the present disclosure. Note that FIG. 2 illustrates the non-roaming architecture; however, similar architectures are defined for roaming and local-breakout architectures. Notably, in the context of Mission Critical (MC) services and LTE/E-UTRAN, the GCS AS includes a MC service server in accordance with 3GPP TS 23.280 and 3GPP TS 23.379. Likewise, for Group Communication in general (which is used herein as a broad term that encompasses MC services such as MC Push to Talk (MCPTT)) in the context of LTE/E-UTRAN, the GCS AS is sometimes referred to herein as a GC server. However, the term “GC server” is not limited to the LTE/E-UTRAN implementation and as such is not limited to being implemented as a GCS AS.

Notably, the UEs 112 include GC clients or MC clients (MCPTT clients) that provide GC or MC service functionality at the UEs 112, as will be appreciated by one of skill in the art.

As described in 3GPP TS 23.280 and TS 23.379, the MC service server makes the decision to transmit information via a unicast bearer or via a multicast (MBMS) bearer. For that, there are different procedures to define how the MBMS bearers are established to be used, e.g. use of pre-established MBMS bearers or by a dynamic MBMS bearer establishment. When a MBMS bearer is established, the MC service server sends a MBMS bearer announcement including information that identifies the MBMS bearer, e.g., the temporary mobile group identity (TMGI). The MC service client in the UE uses the TMGI and other MBMS bearer related information to activate the monitoring of the MBMS bearer by the MC service UE. When the MC service UE enters or is in the MBSFN area of at least one announced TMGI, the MC service UE reports to the MC service server if it is able to receive media over MBMS. This information is sent by the MC service UE via a MBMS listening status report indicating if the MBMS bearer quality is sufficient or not for the UE to receive data. Then, the MC service server makes the decision to use either the MBMS bearer or to switch to a unicast bearer for MC communication sessions.

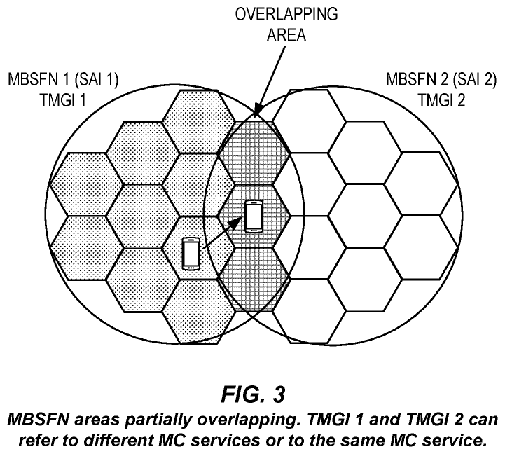

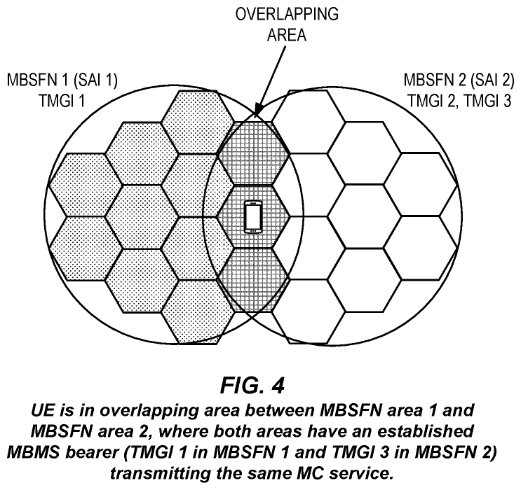

### FIGS. 3-4

Notably, the term “MBSFN area” or “MBSFN coverage area” is used herein (see, e.g., FIGS. 3 and 4 which each illustrate two overlapping MBSFN service areas). As used herein, a coverage area is to be construed as a geographical area, volume, or region wherein a given transmitted radio signal can be received and the information carried by the radio signal successfully interpreted, possibly using also other sources, such as other radio signals transmitted in other coverage areas or networks. Thus, to exemplify, in case the radio signal carries data packets, a coverage area may be defined as an area where a probability of data packet loss after processing of any received radio signals is below some acceptable packet loss probability or bit error rate. In case the radio signal or signals carries voice, a coverage area may, e.g., be defined as an area wherein received signal quality after processing of any received radio signals is sufficient in order for voice quality to be at an acceptable level.

When the MC service UE detects that it suffers from bad MBMS bearer condition for the corresponding MC (MBMS) service, the UE (MC service client) notifies the MC service server about this by sending the MBMS listening status report. Based on this, the MC service server may decide to send the downlink data to the MC service client by a unicast bearer.

One of the reasons for the MC service UE to suffer from bad MBMS bearer conditions is the movement of the UE out of the MBSFN area. MBSFN areas are usually configured to be partially overlapping, i.e. some transmitting radio cells belong to one or more MBSFN areas. Hence, it may be expected that, when a UE is moving out from a MBSFN area (e.g. MBSFN area 1), there is a radio cell that belongs to this MBSFN area (e.g., MBSFN area 1) and to another MBSFN area (e.g. MBSFN area 2). Each MBSFN area is also identified with a service area identifier (SAD. This is depicted in FIG. 3, wherein MBSFN area 1 comprises an established MBMS bearer TMGI 1 and MBSFN area 2 comprises an established MBMS bearer TMGI 2. Note that, FIG. 3 (and likewise FIG. 4) illustrate a number of cells within two MBSFN areas in which MC services can be transmitted. These cells are served or managed by corresponding radio access nodes (e.g., base stations, which in LTE are eNBs), where each radio access node may serve a respective one or more of the cells. In this regard, the radio access nodes may also be referred to herein as MBSFN transmitters.

As an efficient resource utilization technique, it is assumed that the MBSFN areas may not comprise established MBMS bearers transmitting MC services that are not being used. Therefore, in the case depicted in FIG. 3, TMGI 1 and TMGI 2 may be used to transmit different MC services or to transmit the same MC services. When the UE is entering the overlapping area, the MC service client at the UE needs to send a location information report to the MC service server. The location report can include the SAI(s) the UE can monitor. The SAIs can be found by the UE in the system information block (SIB) transmitted by the radio cells. The SIB carries relevant information for the UE about the air interface and radio access network.

For the following description, it is assumed that the UE has previously received a MBMS bearer announcement including the information about the MBSFN service areas, i.e. MBSFN 1/TMGI 1 and MBSFN 2/TMGI 2. In some embodiments of the present disclosure and assuming in FIG. 3 that TMGI 1 and TMGI 2 are used to transmit different MC services, when the MC service server detects that the UE is entering an overlapping area between SAI 1 (i.e. MBSFN area 1) and SAI 2 (i.e. MBSFN area 2), the MC service server proactively establishes a new group communication session via the already established MBMS bearer TMGI 2 in MBSFN area 2. This means that the existing MC service, e.g. a MCPTT call, being transmitted in TMGI 1 is also mapped to the already established bearer in the MBSFN area 2 where the UE is entering, i.e. MBMS bearer TMGI 2. For that, the MC service server sends to the UE a message identifying the MC service data (e.g. MC service media) and the TMGI of the MBMS bearer, such as the MapGroupToBearer message for MCPTT, specified in 3GPP TS 23.379. This MapGroupToBearer message can be sent by the MC service server over a previously activated MBMS bearer, e.g. MBSFN 1/TMGI 1. Thus, the UE can receive simultaneously its MC service data from both MBMS bearers (i.e. TMGI 1 from MBSFN area 1 and TMGI 2 from MBSFN area 2). Thereby, the UE can receive duplicated packets that may also be used e.g. to perform error corrections.

In regard to error correction using the duplicate packets, the transport blocks forming the duplicate packets are combinable upon reception by the UE into combined transport blocks having an improved transport block quality compared to the transport block quality before combining. Now, if there are more bit errors than it is possible to error correct using one transport block, the UE may perform error correction by also considering the duplicate transport block received on the other MBMS bearer, thereby increasing the probability of error correcting the block. The transport blocks transporting the same service on the two separate MBMS bearers are thus combinable upon reception into combined transport blocks having an improved transport block quality compared to the transport block quality before combining. As an alternative or complement to performing error correction based on more than one received transport block, the UE may combine the two transport blocks prior to performing error correction, i.e., perform soft receive diversity combining of the transport blocks transporting the same service. As a further alternative or complement to performing error correction based on more than one received transport block, the UE may perform error correction on both transport blocks individually, and then select the transport block most likely to be correctly decoded as the transport block to use, and discard the other transport block. The transport block most likely to be correctly decoded can be selected by, e.g., determining a Hamming distance between a received transport block and the transport block after error correction.

In another embodiment, if there is not enough capacity on MBSFN 2/TMGI 2 to transmit the UE's required MC service the MC service server can dynamically establish and announce a new MBMS bearer in MBSFN area 2 to transmit the UE's required MC service(s), i.e. the establishment and announcement of TMGI 3 in MBSFN area 2 (i.e. a new MBMS bearer to be used to transmit the same MC service like in MBSFN 1/TMGI 1). Thus, as depicted in FIG. 4, the UE can receive simultaneously data from both MBMS bearers (i.e. TMGI 1 from MBSFN area 1 and TMGI 3 from MBSFN area 2).

As described above, the UE (i.e., the MC service client at the UE) sends, to the MC service server, MBMS listening status reports indicating if the reception quality of the MBMS bearer(s) being monitored is sufficient or not for the UE to receive data. Nevertheless, this MBMS listening status report can be enhanced to include multiple reception quality levels in order to provide further bearer quality information to the MC service server. Based on this, as a further embodiment, this MBMS multi-level bearer quality indicator can be used by the MC service server to make a decision about, e.g., proactively establishing a new group communication session via an already established MBMS bearer in another MBSFN area, or proactively establishing a new bearer in another MBSFN area (as described above), or proactively establishing a unicast bearer to efficiently switch from a multicast bearer to a unicast bearer (simultaneous transmission over multicast and unicast can also be considered). Hence, the service continuity for the UE can be efficiently maintained. For instance, the MBMS multi-level bearer quality indicator can comprise four different levels: very good, good, sufficient, insufficient. These levels can be determined by the UE based on the SINR of the MBMS bearer.

In an embodiment, the MC service server can monitor over a period of time the value of the MBMS multi-level bearer quality indicator of the different MBMS bearer being reported by the UE. Thus, the MC service server can efficiently decide when to proactively establish an additional bearer, e.g. a unicast bearer, to provide a MC service to the UE simultaneously from a multicast bearer and a unicast bearer. So that, when the UE detects that it is suffering from bad MBMS bearer condition, e.g., a sufficient or insufficient bearer quality level, the UE is already receiving data via the unicast bearer. This avoids interruption of the MC service.

When a UE enters an overlapping area between two MBSFN areas (as depicted in FIG. 3 and assuming that TMGI 1 and TMGI 2 are used to transmit different MC services), the UE sends the location information report including both SAIs (i.e. SAI 1 and SAI 2) and starts reporting the MBMS bearer quality of the MBMS bearers being monitored via the MBMS listening status report. Based on this, in another embodiment, before the MC service server establishes a new group communication session via an already established MBMS bearer in another MBSFN area the MC service server can first properly determine based on the MBMS multi-level bearer quality indicator if the quality level of that other bearer is sufficient to transmit the required MC service. Likewise, the MC service server can utilize the MBMS multi-level bearer quality indicator to properly combine the quality of the bearers being reported, e.g. MBSFN 1/TMGI 1 and MBSFN 2/TMGI 2, in order to determine if a simultaneous reception from both bearers does reach a sufficient quality for a successful MC service transmission.

Likewise, before the MC service server establishes and announces a MBMS bearer in MBSFN area 2 for the UE's required MC service (i.e. TMGI 3 in MBSFN area 2) and taking into account that this process can take several milliseconds, the MC service server can first properly determine if the MBMS bearer establishment of TMGI 3 in MBSFN 2 is really needed. For that, the MC service server can utilize the MBMS multi-level bearer quality indicator related to TMGI 1 in MBSFN area 1. Hence, if the MBMS multi-level bearer quality indicator for TMGI 1 in MBSFN area 1 is still defined as very good or good the MC service server can hold this decision and instead monitor how the quality level varies. Thus, an efficient resource utilization is maintained. Once the MC service server monitors (based on the received MBMS multi-level bearer quality indicator) that the quality level is decreasing, e.g. when it is changing from very good to good or below, the MC service server can decide to establish and announces TMGI 3 in MBSFN area 2 (leading to the case depicted in FIG. 4).

In a further embodiment, when a UE is within an overlapping area between two MBSFN areas and is receiving its MC service simultaneously on the MBMS bearers from both MBSFN areas (as depicted in FIG. 3 and assuming that TMGI 1 and TMGI 2 refer to the same MC service), the MC service server can combine the value of the MBMS multi-level bearer quality indicator from both MBSFN areas, i.e. TMGI 1 quality level and TMGI 2 quality level. Thus, even though the bearer quality level of a MBMS bearer is just sufficient but the other one is very good or good, the combined resulting SINR can be still good enough to maintain a successful multicast transmission. On the other hand, if the combined quality level is below good, then the MC service server can decide to switch to a unicast transmission for the UE. In another embodiment, the MC service server can efficiently use the combined quality level to efficiently determine maintaining service continuity between two MBSFN areas instead of switching to a unicast bearer, which might not have an appropriate transmission quality in case network congestion.

Below two cases are described comprising some of the described embodiments above.

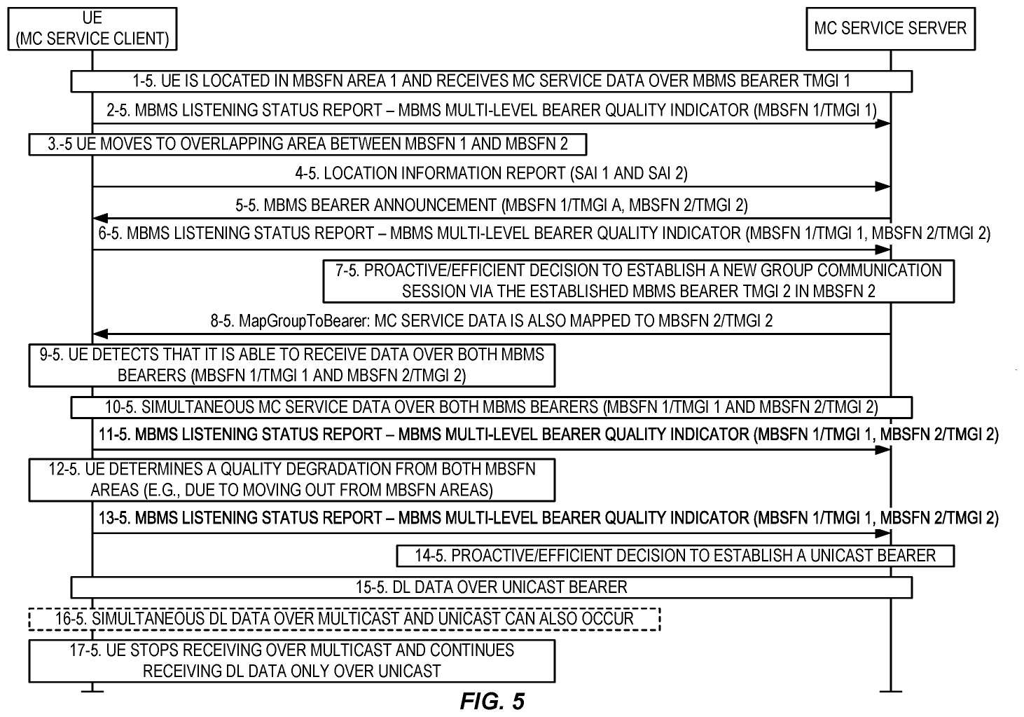

### FIG. 5

Case 1 (depicted in FIG. 5): Dynamic establishment procedure of a new group communication session via an already established MBMS bearer in MBSFN area 2 (i.e. TMGI 2):
1-5. The UE with the MC service client is within the MBSFN area 1 and receives the MC service data (e.g. MC service media) over MBMS bearer TMGI 1. In other words, the UE is located in MBSFN 1 and can listen to TMGI 1. No additional MBMS bearers that the UE is interested in are active in the current cell.
2-5. The MC service client in the UE sends to the MC service server a MBMS listening status report including the MBMS multi-level bearer quality indicator related to MBSFN 1/TMGI 1. In other words, the UE with the MC service client notifies the MC service server that it is successfully receiving the MC service media over TMGI 1 as well as at which reception quality level. The reception quality level of the MBMS bearer can be used by the MC service server to make an efficient decision to switch to another MBMS bearer or to a unicast bearer (e.g. when the quality level indicates that the reception quality of the MBMS bearer is decreasing).
3-5. The UE moves into the overlapping area between MBSFN area 1 and MBSFN area 2. The UE has not been previously indicated by the MC service server to monitor any MBMS bearer in MBSFN area 2. In other words, the UE moves into a new cell in which both TMGI 1 and TMGI 2 are active. This cell is part of both MBSFN area 1 and MBSFN area 2, and it broadcasts the same service on both TMGIs.
4-5. The UE sends a location information report to the MC service server reporting that it has detected SAI 1 and SAI 2. In other words, The UE comprising the MC service client sends a location information report to the MC service server. For that, the UE uses the SAI information found in the system information block (SIB) transmitted by the radio cells. Note that, in one exemplary LTE setting, the UE detects SAI 1 and SAI 2 by reading System Information Block (SIB) 2 transmitted on a cell within the overlapping area between MBSFN area 1 and MBSFN area 2. SIB2 contains information relating to the sub-frames that are being used for MBMS. The UE also receives SIB 13, which enables the UE to locate the so-called MBMS Control Channel (MCCH) in the LTE radio frame structure. The MCCH, in turn, carries information allowing the UE to discover which SAI(s) and TMGI(s) are available, and where broadcasted media corresponding to the TMGIs can be found, i.e., which communications resources that are used for broadcasting which services.
5-5. The MC service server sends to the MC service client a MBMS bearer announcement indicating that the UE should monitor MBSFN 1/TMGI 1 and MBSFN 2/TMGI 2. In other words, the MC service server sends to the receiving UE with the MC service client a MBMS bearer announcement with information related to TMGI 2 (if the MC service server had not done it before). Hence, the MC service client knows that TMGI 2 transmits the same MC service media.
6-5. The MC service client in the UE sends to the MC service server a MBMS listening status report including the MBMS multi-level bearer quality indicator related to MBSFN 1/TMGI 1 and MBSFN 2/TMGI 2. In other words, the UE with the MC service client notifies the MC service server that it is successfully receiving TMGI 1 and TMGI 2 as well as at which reception quality level per TMGI.
7-5. The MC service server decides to proactively establish a new group communication session via the already established MBMS bearer TMGI 2 in MBSFN area 2 to transmit the UE's MC service. For instance, it is assumed that the MC service server determines that the quality of both bearers (or the combined quality of both bearers) is good enough to maintain the multicast transmission.
8-5. The MC service server sends to the MC service client a MapGroupToBearer message to indicate that the UE's MC service data is also mapped to TMGI 2 in MBFSN 2.
9-5. The UE detects that it is able to receive data over both MBMS bearers. This means that the bearer quality of both MBMS bearers is good enough to successfully receive the data.
10-5. The UE with the MC service client receives simultaneously data over both MBMS bearers, i.e. MBSFN 1/TMGI 1 and MBSFN 2/TMGI 2. In other words, the UE receives information over both MBMS bearers, i.e. TMGI 1 and TMGI 2. The MC service client may also verify that it is the same content sent on both bearers. The duplicated packets may also be used to perform error corrections.
11-5. The UE sends to the MC service server a MBMS listening status report including the MBMS multi-level bearer quality indicator related to MBSFN 1/TMGI 1 and MBSFN 2/TMGI 2. In this step, it is assumed that the MC service server determines that the quality of both bearers (or the combined quality of both bearers) is good enough to maintain the multicast transmission.
12-5. The UE determines a quality degradation from both MBMS bearers, e.g. due to the UE moving out from both MBSFN areas. This step can also be considered for the case the UE is receiving a multicast transmission from only one MBSFN area and is moving to an area out of MBMS coverage, i.e. where only unicast transmissions are supported.
13-5. The UE sends to the MC service server a MBMS listening status report including the MBMS multi-level bearer quality indicator related to MBSFN 1/TMGI 1 and MBSFN 2/TMGI 2.
14-5. The MC service server determines that the quality of the MBMS bearers is decreasing. For this example, when the UE is moving out from both MBSFN areas, can be expected that even the combined quality of both bearers will keep decreasing. Therefore, the MC service server proactively and in an efficient way (before a service interruption may occur) establishes a unicast bearer for the UE.
15-5. The UE now receives the MC service data over the unicast transmission.
16-5. If the quality of the multicast transmission is still good enough to successfully receive data, the UE can then simultaneously receive the same data over both multicast and unicast transmissions.
17-5. Once the UE determines that the quality of the MBMS bearer is not sufficient to receive data or the UE cannot longer detect TMGI 1 or TMGI 2 (e.g. due to the UE being out from the MBSFN areas), the UE stops receiving data over the multicast transmission and continue receiving data only over the unicast transmission.

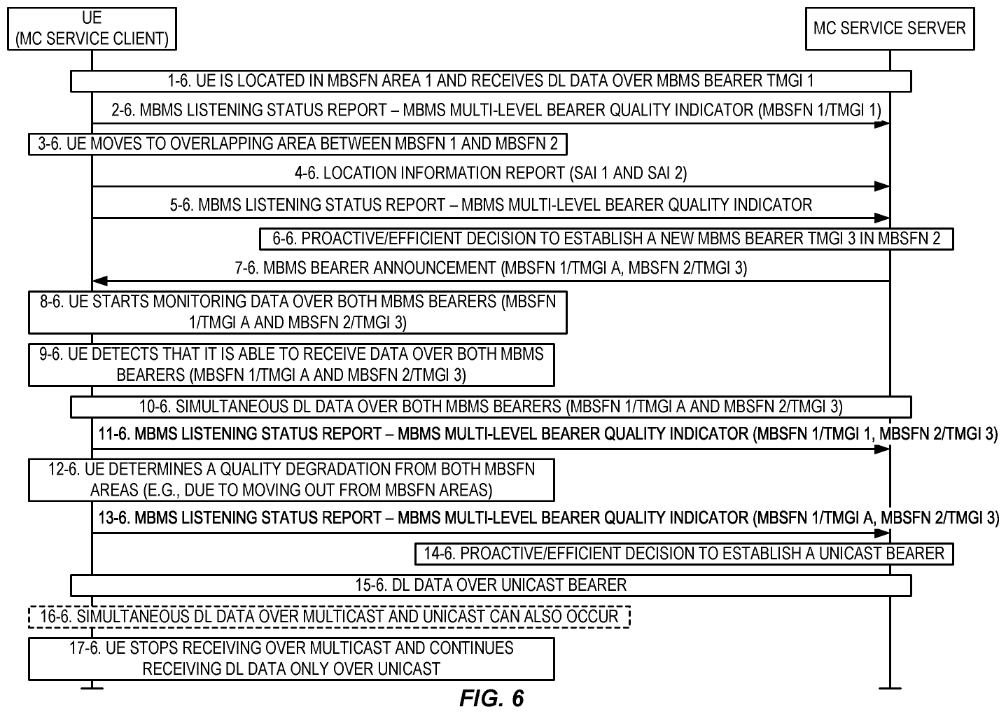

### FIG. 6

Case 2 (depicted in FIG. 6): Dynamic MBMS/Unicast bearer establishment procedure due to no sufficient capacity in MBSFN area 2/TMGI 2:
1-6. The UE is within the MBSFN area 1 and receives the MC service data over MBMS bearer TMGI 1. In other words, the UE is located in MBSFN 1 and can listen to TMGI 1. No additional MBMS bearers that the UE with the MC service client is interested in are active in the current cell.
2-6. The MC service client in the UE sends to the MC service server a MBMS listening status report including the MBMS multi-level bearer quality indicator related to MBSFN 1/TMGI 1. In other words, the UE with the MC service client notifies the MC service server that it is successfully receiving the MC service media over TMGI 1 as well as at which reception quality level. The reception quality level of the MBMS bearer can be used by the MC service server to make an efficient decision to switch to another MBMS bearer or to a unicast bearer (e.g. when the quality level indicates that the reception quality of the MBMS bearer is decreasing).
3-6. The UE moves into the overlapping area between MBSFN area 1 and MBSFN area 2. The UE has not been previously indicated by the MC service server to monitor any MBMS bearer in MBSFN area 2. In other words, the UE moves into a new cell in which both TMGI 1 and TMGI 2 are active. This cell is part of both MBSFN area 1 and MBSFN area 2, and it broadcasts the same service on both TMGIs.
4-6. The UE sends a location information report to the MC service server reporting that it has detected SAI 1 and SAI 2. In other words, The UE comprising the MC service client sends a location information report to the MC service server. For that, the UE uses the SAI information found in the system information block (SIB) transmitted by the radio cells. Note that, in one exemplary LTE setting, the UE detects SAI 1 and SAI 2 by reading System Information Block (SIB) 2 transmitted on a cell within the overlapping area between MBSFN area 1 and MBSFN area 2. SIB2 contains information relating to the sub-frames that are being used for MBMS. The UE also receives SIB 13, which enables the UE to locate the so-called MBMS Control Channel (MCCH) in the LTE radio frame structure. The MCCH, in turn, carries information allowing the UE to discover which SAI(s) and TMGI(s) are available, and where broadcasted media corresponding to the TMGIs can be found, i.e., which communications resources that are used for broadcasting which services.
5-6. The MC service client in the UE sends to the MC service server a MBMS listening status report including the MBMS multi-level bearer quality indicator. In other words, the UE with the MC service client notifies the MC service server that it is successfully receiving TMGI 1 and TMGI 2 as well as at which reception quality level per TMGI.
6-6. The MC service server decides to proactively establish a new MBMS bearer TMGI 3 in MBSFN area 2 (e.g. due to no sufficient capacity in TMGI 2). This is based on the information received in the MBMS listening status report and location and the location information report. For instance, it can be assumed that the MBMS multi-level bearer quality indicator related to MBSFN 1/TMGI 1 was at a not very good level, or that the MC service server identifies that the UE is moving out from MBSFN area 1 in to MBSFN area 2, or that a combination of simultaneously receiving both MBMS bearers from MBSFN area 1 and MBSFN area 2 can improve the reception of the data.
7-6. The MC service server sends to the MC service client a MBMS bearer announcement indicating that the UE should monitor MBSFN 1/TMGI 1 and MBSFN 2/TMGI 3. This means for the UE that the its MC service is being transmitted in both MBSFN areas.
8-6. The UE starts monitoring TMGI 1 and TMGI 3 in both MBSFN areas.
9-6. The UE detects that it is able to receive data over both MBMS bearers. This means that the bearer quality of both MBMS bearers is good enough to successfully receive the data.
10-6. The UE with the MC client receives simultaneously data over both MBMS bearers, i.e. MBSFN 1/TMGI 1 and MBSFN 2/TMGI 3. In other words, the UE receives information over both MBMS bearers, i.e. TMGI 1 and TMGI 2. The MC service client may also verify that it is the same content sent on both bearers. The duplicated packets may also be used to perform error corrections.
11-6. The UE sends to the MC service server a MBMS listening status report including the MBMS multi-level bearer quality indicator related to MBSFN 1/TMGI 1 and MBSFN 2/TMGI 3. In this step, it is assumed that the MC service server determines that the quality of both bearers (or the combined quality of both bearers) is good enough to maintain the multicast transmission.
12-6. The UE determines a quality degradation from both MBMS bearers, e.g. due to the UE moving out from both MBSFN areas. This step can also be considered for the case the UE is receiving a multicast transmission from only one MBSFN area and is moving to an area out of MBMS coverage, i.e. where only unicast transmissions are supported.
13-6. The UE sends to the MC service server a MBMS listening status report including the MBMS multi-level bearer quality indicator related to MBSFN 1/TMGI 1 and MBSFN 2/TMGI 3.
14-6. The MC service server determines that the quality of the MBMS bearers is decreasing. For this example where the UE is moving out from both MBSFN areas, it can be expected that even the combined quality of both bearers will keep decreasing. Therefore, the MC service server proactively and in an efficient way (before a service interruption may occur) establishes a unicast bearer for the UE.
15-6. The UE now receives the MC service data over the unicast transmission.
16-6. If the quality of the multicast transmission (i.e. the quality of the MBMS bearer TMGI 1 from any of the MBSFN areas) is still good enough to successfully receive data, the UE can then simultaneously receive the same data over both multicast and unicast transmissions.
17-6. Once the UE determines that the quality of the MBMS bearer is not sufficient to receive data or the UE cannot longer detect TMGI 1 (e.g. due to the UE being out from the MBSFN area), the UE stops receiving data over the multicast transmission and continue receiving data only over the unicast transmission

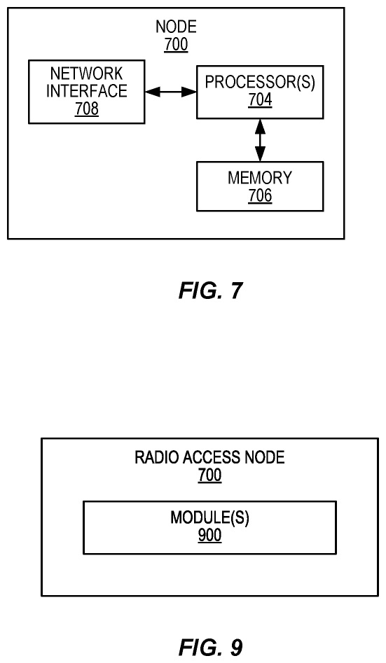

### FIG. 7

FIG. 7 is a schematic block diagram of a node 700 implementing a GC server or a MC service server according to some embodiments of the present disclosure. As illustrated, the node 700 includes one or more processors 704 (e.g., Central Processing Units (CPUs), Application Specific Integrated Circuits (ASICs), Field Programmable Gate Arrays (FPGAs), and/or the like), memory 706, and a network interface 708. The one or more processors 704 are also referred to herein as processing circuitry. The one or more processors 704 operate to provide one or more functions of a GC server or MC service server as described herein (e.g., with respect to FIGS. 5 and/or 6). In some embodiments, the function(s) are implemented in software that is stored, e.g., in the memory 706 and executed by the one or more processors 704. Notably, the node 700 may include additional components that are no illustrated in FIG. 7 (e.g., one or more user interface components such as, e.g., a display and/or input device, a power supply, and/or the like).

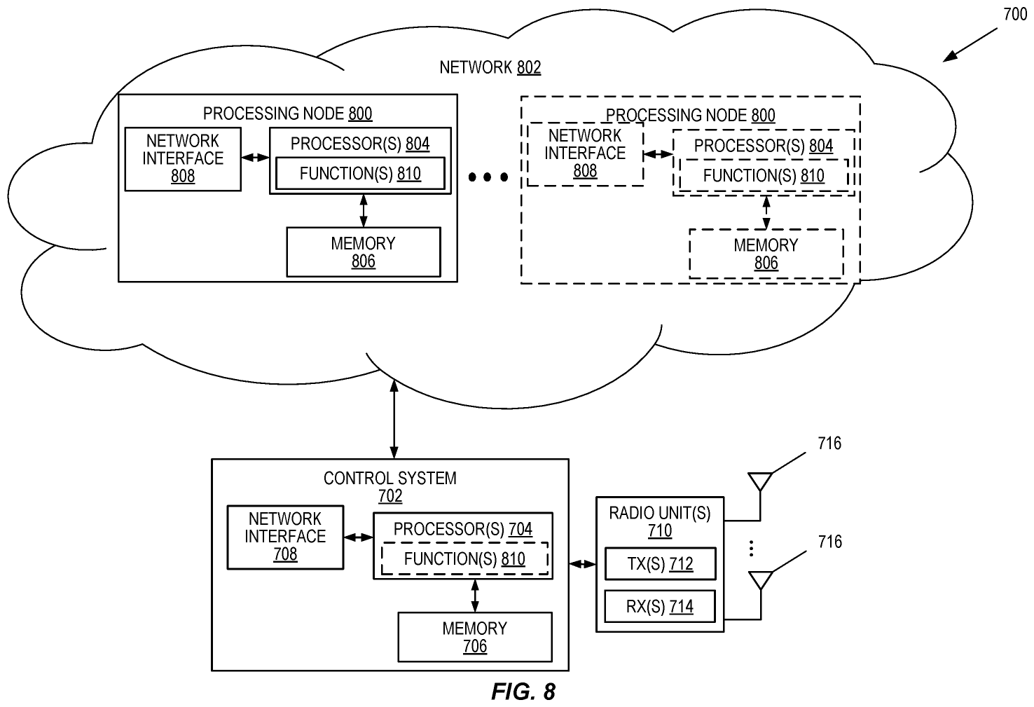

### FIG. 8

FIG. 8 is a schematic block diagram that illustrates a virtualized embodiment of a GC server or MC service server according to some embodiments of the present disclosure. As used herein, a “virtualized” GC server or MC service server is an implementation of the GC server or MC service server in which at least a portion of the functionality of the GC server or MC service server is implemented as a virtual component(s) (e.g., via a virtual machine(s) executing on a physical processing node(s) in a network(s)). As illustrated, in this example, One or more processing nodes 800 are coupled to or included as part of a network(s) 802 via the network interface 708. Each processing node 800 includes one or more processors 804 (e.g., CPUs, ASICs, FPGAs, and/or the like), memory 806, and a network interface 808.

In this example, functions 810 of the GC server or MC service server described herein are implemented at the one or more processing nodes 800. In some particular embodiments, some or all of the functions 810 of the GC server or MC service server described herein are implemented as virtual components executed by one or more virtual machines implemented in a virtual environment(s) hosted by the processing node(s) 800.

In some embodiments, a computer program including instructions which, when executed by at least one processor, causes the at least one processor to carry out the functionality of GC server or MC service server according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 9

FIG. 9 is a schematic block diagram of the node 700 according to some other embodiments of the present disclosure. The node 700 includes one or more modules 900, each of which is implemented in software. The module(s) 900 provide the functionality of the GC server or MC service server described herein. This discussion is equally applicable to the processing node 800 of FIG. 8 where the modules 900 may be implemented at one of the processing nodes 800 or distributed across multiple processing nodes 800.

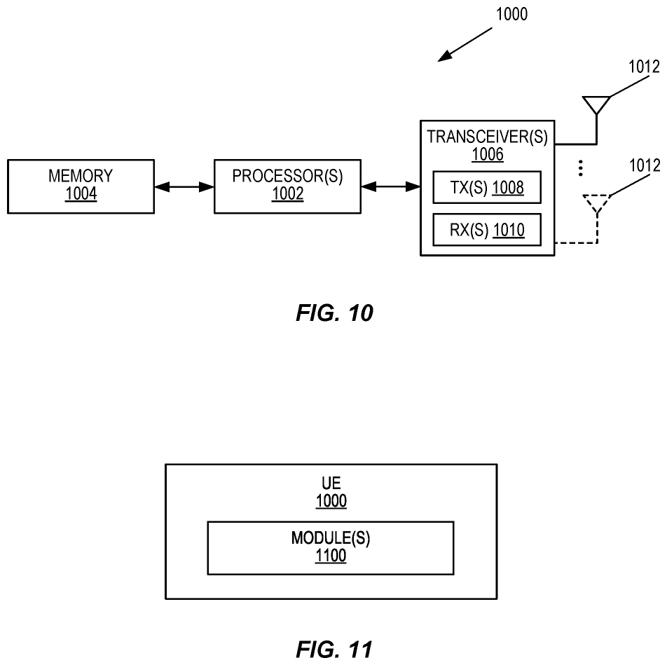

### FIG. 10

FIG. 10 is a schematic block diagram of a UE 1000 according to some embodiments of the present disclosure. As illustrated, the UE 1000 includes one or more processors 1002 (e.g., CPUs, ASICs, FPGAs, and/or the like), memory 1004, and one or more transceivers 1006 each including one or more transmitters 1008 and one or more receivers 1010 coupled to one or more antennas 1012. The transceiver(s) 1006 includes radio-front end circuitry connected to the antenna(s) 1012 that is configured to condition signals communicated between the antenna(s) 1012 and the processor(s) 1002, as will be appreciated by on of ordinary skill in the art. The processors 1002 are also referred to herein as processing circuitry. The transceivers 1006 are also referred to herein as radio circuitry. In some embodiments, the functionality of the UE 1000 described above (e.g., the functionality of the UE and/or the GC client or MC service client described herein, e.g., with respect to FIG. 5 and/or FIG. 6) may be fully or partially implemented in software that is, e.g., stored in the memory 1004 and executed by the processor(s) 1002. Note that the UE 1000 may include additional components not illustrated in FIG. 10 such as, e.g., one or more user interface components (e.g., an input/output interface including a display, buttons, a touch screen, a microphone, a speaker(s), and/or the like and/or any other components for allowing input of information into the UE 1000 and/or allowing output of information from the UE 1000), a power supply (e.g., a battery and associated power circuitry), etc.

In some embodiments, a computer program including instructions which, when executed by at least one processor, causes the at least one processor to carry out the functionality of the UE 1000 (e.g., the functionality of the UE and/or the GC client or MC service client described herein, e.g., with respect to FIG. 5 and/or FIG. 6) according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 11

FIG. 11 is a schematic block diagram of the UE 1000 according to some other embodiments of the present disclosure. The UE 1000 includes one or more modules 1100, each of which is implemented in software. The module(s) 1100 provide the functionality of the UE 1000 described herein (e.g., the functionality of the UE and/or the GC client or MC service client described herein, e.g., with respect to FIG. 5 and/or FIG. 6).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Some Embodiments Described Above May Be Summarized in the Following Manner:

1. A method performed by a wireless device (112) comprising a Mission Critical, MC, service client to enable reception of transmissions for a MC service, the method comprises the steps of:

receiving (1-5, 1-6) MC service media for a MC service over a first Multicast-Broadcast Multimedia Service, MBMS, bearer identified by a first Temporary Mobile Group Identity, TMGI, (TMGI 1), while the wireless device is located in a first Multicast-Broadcast Single Frequency Network, MBSFN, area (MBSFN 1);

sending (2-5, 2-6) to a MC service server (114) a first MBMS listening status report notifying the MC service server that the MC service media is successfully received over the first MBMS bearer, and including a first MBMS bearer quality indicator that indicates a reception quality level related to the first MBMS bearer;

sending (4-5, 4-6) a location information report to the MC service server indicating that the wireless device is now located in an overlapping area between the first MBSFN area and a second MBSFN area (MBSFN 2), in which overlapping area both the first MBMS bearer and a second MBMS bearer identified by a second TMGI (TMGI 2) are active;

receiving (5-5) a MBMS bearer announcement with information relating to the second MBMS bearer indicating to the wireless device that the first MBMS bearer and the second MBMS bearer transmit the same MC service media; and

sending (6-5, 5-6) to the MC service server a second MBMS listening status report notifying the MC service server that MC service media can be successfully received over the first MBMS bearer and the second MBMS bearer, and including a second MBMS bearer quality indicator that indicates a reception quality level related to the first MBMS bearer and a reception quality level related to the second MBMS bearer;
2. The method of embodiment 1 wherein at least one of; the first MBMS bearer quality indicator is a multi-level bearer quality indicator, and/or the second MBMS bearer quality indicator is a multi-level bearer quality indicator.
3. The method of any one of embodiment 1 or 2, wherein the second MBMS bearer in the second MBSFN is a different MBMS bearer than the first MBMS bearer in the first MBSFN.
4. The method of any one of embodiment 1 to 3 wherein, after receiving the MBMS bearer announcement message that indicates that the MC service media is also transmitted on the second MBMS bearer in the second MBSFN area, receiving (10-5, 10-6) MC service media over both the first MBMS bearer and the second MBMS bearer.
5. The method of embodiment 4 further comprising at least one of; verifying that the same MC service media is sent on both MBMS bearers, and/or using the duplicated MC service media to perform error corrections.
6. A wireless device (112) adapted to perform the method of any one of embodiment 1 to 5.
7. A wireless device (112) comprising:

one or more transmitters;

one or more receivers; and

processing circuitry associated with the one or more transmitters and the one or more receivers, the processing circuitry configured to cause the wireless device to perform the method of any one of embodiments 1 to 5.
8. A method performed by node to implement a Mission Critical (MC) service server (114), the method comprises the steps of:

receiving (2-5, 2-6) from a wireless device (112) while it is located in a first Multicast-Broadcast Single Frequency Network, MBSFN, area (MBSFN 1), a first MBMS listening status report notifying the MC service server that MC service media is successfully received over a first MBMS bearer identified by a first Temporary Mobile Group Identity, TMGI, (TMGI 1), and including a first MBMS bearer quality indicator that indicates a reception quality level related to the first MBMS bearer;

receiving (4-5, 4-6) from the wireless device, a location information report indicating that the wireless device is now located in an overlapping area between the first MBSFN area and a second MBSFN area (MBSFN 2), in which overlapping area both the first MBMS bearer and a second MBMS bearer identified by a second TMGI (TMGI 2) are active;

sending (5-5) to the wireless device, a MBMS bearer announcement with information relating to the second MBMS bearer indicating to the wireless device that the first MBMS bearer and the second MBMS bearer transmit the same MC service media; and

receiving (6-5, 5-6) from the wireless device, a second MBMS listening status report notifying the MC service server that MC service media can be successfully received over the first MBMS bearer and the second MBMS bearer, and including a second MBMS bearer quality indicator that indicates a reception quality level related to the first MBMS bearer and a reception quality level related to the second MBMS bearer;
9. The method of embodiment 8 wherein at least one of; the first MBMS bearer quality indicator is a multi-level bearer quality indicator, and/or the second MBMS bearer quality indicator is a multi-level bearer quality indicator.
10. The method of embodiment 8 or 9 wherein the second MBMS bearer in the second MBSFN is a different MBMS bearer than the first MBMS bearer in the first MBSFN.
11. The method of any one of embodiment 8 to 10 wherein, after receiving the MBMS bearer announcement message that indicates that the MC service media is also transmitted on the second MBMS bearer in the second MBSFN area, receiving (10-5, 10-6) MC service media over both the first MBMS bearer and the second MBMS bearer.
12. The method of embodiment 11 further comprising at least one of; verifying that the same MC service media is sent on both MBMS bearers, and/or using the duplicated MC service media to perform error corrections.
13. A node (114) adapted to perform the method of any one of embodiment 8 to 12.
14. A node (114) comprising:

a network interface; and

processing circuitry associated with the network interface, the processing circuitry configured to cause the node to perform the method of any one of embodiment 8 to 12.
15. A method performed by a wireless device (112) comprising a Mission Critical, MC, service client to enable reception of transmissions for a MC service, which wireless device is located in an overlapping area between a first—Broadcast Single Frequency Network, MBSFN, area (MBSFN 1) and a second MBSFN area (MBSFN 2), in which overlapping area both a first MBMS bearer identified by a first TMGI (TMGI 2) and a second MBMS bearer identified by a second TMGI (TMGI 2) are active. the method comprises the steps of:

sending (6-5, 5-6) to a MC service server (114) a MBMS listening status report notifying the MC service server that MC service media can be successfully received over the first MBMS bearer and the second MBMS bearer, and including a MBMS bearer quality indicator that indicates a reception quality level related to the first MBMS bearer and a reception quality level related to the second MBMS bearer;
16. The method of embodiment 15 wherein the MBMS bearer quality indicator is a multi-level bearer quality indicator.
17. The method of any one of embodiment 15 or 16, wherein the second MBMS bearer in the second MBSFN is a different MBMS bearer than the first MBMS bearer in the first MBSFN.
18. The method of any one of embodiment 15 to 17, wherein the method comprises the further step of: receiving (10-5, 10-6) MC service media over both the first MBMS bearer and the second MBMS bearer.
19. The method of embodiment 18 further comprising at least one of; verifying that the same MC service media is sent on both MBMS bearers, and/or using the duplicated MC service media to perform error corrections.

### Some Further Embodiments Described Above May Be Summarized in the Following Manner:

1. A method performed by a wireless device to enable reception of transmissions for a Group Communication, GC, service (e.g., a Mission Critical (MC) service such as, e.g., MC Push-to-Talk (MCPTT)), the method comprising one or more of:

receiving (FIG. 5, step 1; FIG. 6, step 1) GC service data (e.g., MC service data) for a GC service (e.g., a MC service) over a first Multicast-Broadcast Multimedia Service, MBMS, bearer while the wireless device is located in a first Multicast-Broadcast Single Frequency Network, MBSFN, area;

reporting (FIG. 5, step 4; FIG. 6, step 4 and/or FIG. 5, step 6; FIG. 6, step 5), to a GC server (e.g., a MC service server), information that indicates at least one of: that the wireless device is located in an overlapping area between the first MBSFN area and a second MBSFN area and/or a reception quality of the first MBMS bearer in the first MBSFN area;

receiving (FIG. 5, step 8; FIG. 6, step 7), from the GC server, a message that indicates that the GC service data for the GC service is also being transmitted on a second MBMS bearer in the second MBSFN area; and

optionally, in response to receiving the message that indicates that the GC service data is also being transmitted on a second MBMS bearer, receiving (FIG. 5, step 10; FIG. 6, step 10) GC service data for the GC service over at least the second MBMS bearer and optionally also over the first MBMS bearer.
2. The method of embodiment 1 wherein the information that indicates the quality of the first MBMS bearer in the first MBSFN area is a multi-level bearer quality indicator.
3. The method of embodiment 1 or 2 wherein the second MBMS bearer in the second MBSFN is a different MBMS bearer than the first MBMS bearer in the first MBSFN (e.g., different TMGIs).
4. The method of embodiment 3 further comprising, after reporting the information that indicates that the wireless device is located in the overlapping area between the first MBSFN area and the second MBSFN area, receiving (FIG. 5, step 5) an MBMS bearer announcement comprising information that indicates the second MBMS bearer in the second MBSFN.
5. The method of embodiment 3 or 4 wherein reporting (FIG. 5, step 6; FIG. 6, step 5) the information that indicates the quality of the first MBMS bearer in the first MBSFN area comprises reporting (FIG. 5, step 6), to the GC server, information that indicates the quality of the first MBMS bearer in the first MBSFN area and information that indicates a quality of the second MBMS bearer in the second MBSFN area.
6. The method of embodiment 5 wherein:

the information that indicates the quality of the first MBMS bearer in the first MBSFN area comprises a multi-level bearer quality indicator for the first MBMS bearer in the first MBSFN area; and

the information that indicates the quality of the second MBMS bearer in the second MBSFN area comprises a multi-level bearer quality indicator for the second MBMS bearer in the second MBSFN area
7. The method of any one of embodiments 3 to 6 wherein receiving (FIG. 5, step 8; FIG. 6, step 7) the message that indicates that GC service data for the GC service is also being transmitted on the second MBMS bearer in the second MBSFN area comprises receiving (FIG. 5, step 8), from the GC server, a message (e.g., a MapGroupToBearer message) that indicates that the GC data for the GC service is also mapped to the second MBMS bearer in the second MBSFN area.
8. The method of embodiment 1 or 2 wherein the second MBMS bearer in the second MBSFN transmits the same GC data for a GC service as the first MBMS bearer in the first MBSFN (e.g., same TMGIs).
9. The method of embodiment 8 wherein receiving (FIG. 5, step 8; FIG. 6, step 7) the message that indicates that GC service data for the GC service is also being transmitted on the second MBMS bearer in the second MBSFN area comprises receiving (FIG. 6, step 7), from the GC server, a MBMS bearer announcement message that indicates that the GC data for the GC service is also transmitted on the second MBMS bearer in the second MBSFN area.
10. The method of embodiment 9 wherein, after receiving (FIG. 6, step 7) the MBMS bearer announcement message that indicates that the GC data for the GC service is also transmitted on the second MBMS bearer in the second MBSFN area, starting (FIG. 6, step 8) to monitor GC data over both the first MBMS bearer and the second MBMS bearer.
11. The method of any one of embodiments 1 to 10 further comprising:

sending (FIG. 5, step 13; FIG. 6, step 13), to the GC server, information that indicates that a quality degradation for both the first MBMS bearer and the second MBMS bearer; and

receiving (FIG. 5, step 15; FIG. 6, step 15) GC data for the GC service over a unicast bearer.
12. The method of embodiment 11 further comprising terminating (FIG. 5, step 17; FIG. 6, step 17) reception of GC data for the GC service over the first MBMS bearer and the second MBMS bearer.
13. A method performed by a wireless device to enable reception of transmissions for a Group Communication, GC, service (e.g., a Mission Critical (MC) service such as, e.g., MC Push-to-Talk (MCPTT)), the method comprising one or more of:

receiving (FIG. 5, step 1; FIG. 6, step1) GC service data (e.g., MC service data) for a GC service (e.g., a MC service) over a first Multicast-Broadcast Multimedia Service, MBMS, bearer while the wireless device is located in a first Multicast-Broadcast Single Frequency Network, MBSFN, area; and

reporting (FIG. 5, step 2; FIG. 6, step 2), to the GC server, a multi-level bearer quality indicator for the first MBMS bearer in the first MBSFN area.
14. A wireless device adapted to perform the method of any one of embodiments 1 to 13.
15. A wireless device comprising:

one or more transmitters;

one or more receivers; and

processing circuitry associated with the one or more transmitters and the one or more receivers, the processing circuitry configured to cause the wireless device to perform the method of any one of embodiments 1 to 14.
16. A method performed by node to implement a Group Communication, GC, service server (e.g., a Mission Critical (MC) service server such as, e.g., MC Push-to-Talk (MCPTT) service server), the method comprising one or more of:

receiving (FIG. 5, step 4; FIG. 6, step 4 and/or FIG. 5, step 6; FIG. 6, step 5), from a wireless device, information that indicates that the wireless device is located in an overlapping area between a first Multicast-Broadcast Single Frequency Network, MBSFN, area and a second MBSFN area, wherein GC data for a GC service (e.g., a MC service such as MCPTT) is transmitted on a first Multicast-Broadcast Multimedia Service, MBMS, in the first MBSFN area and/or information that indicates a quality of the first MBMS bearer in the first MBSFN area;

proactively deciding (FIG. 5, step 7; FIG. 6, step 6) to start transmitting GC data for the GC service also on a second MBMS bearer in the second MBSFN area; and

sending (FIG. 5, step 8; FIG. 6, step 7), to the wireless device, a message that indicates that GC service data for the GC service is also being transmitted on the second MBMS bearer in the second MBSFN area.
17. The method of embodiment 16 further comprising transmitting (FIG. 5, step 10; FIG. 6, step 10) GC service data for the GC service over both the first MBMS bearer and the second MBMS bearer.
18. The method of embodiment 16 or 17 wherein the information that indicates the quality of the first MBMS bearer in the first MBSFN area is a multi-level bearer quality indicator.
19. The method of any one of embodiments 16 to 18 wherein the second MBMS bearer in the second MBSFN is a different MBMS bearer than the first MBMS bearer in the first MBSFN (e.g., different TMGIs).
20. The method of embodiment 19 further comprising, after receiving the information that indicates that the wireless device is located in the overlapping area between the first MBSFN area and the second MBSFN area, transmitting (FIG. 5, step 5), to the wireless device, an MBMS bearer announcement comprising information that indicates the second MBMS bearer in the second MBSFN.
21. The method of embodiment 19 or 20 wherein receiving (FIG. 5, step 6; FIG. 6, step 5) the information that indicates the quality of the first MBMS bearer in the first MBSFN area comprises receiving (FIG. 5, step 6), from the wireless device, information that indicates the quality of the first MBMS bearer in the first MBSFN area and information that indicates a quality of the second MBMS bearer in the second MBSFN area.
22. The method of embodiment 21 wherein:

the information that indicates the quality of the first MBMS bearer in the first MBSFN area comprises a multi-level bearer quality indicator for the first MBMS bearer in the first MBSFN area; and

the information that indicates the quality of the second MBMS bearer in the second MBSFN area comprises a multi-level bearer quality indicator for the second MBMS bearer in the second MBSFN area
23. The method of embodiment 21 or 22 wherein proactively deciding (FIG. 5, step 7; FIG. 6, step 6) to start transmitting GC data for the GC service also on the second MBMS bearer in the second MBSFN area comprises proactively deciding (FIG. 5, step 7) to start transmitting GC data for the GC service also on the second MBMS bearer in the second MBSFN area based on the information that indicates the quality of the first MBMS bearer in the first MBSFN area and the information that indicates a quality of the second MBMS bearer in the second MBSFN area.
24. The method of any one of embodiments 19 to 23 wherein proactively deciding (FIG. 5, step 7; FIG. 6, step 6) to start transmitting GC data for the GC service also on the second MBMS bearer in the second MBSFN area comprises proactively deciding (FIG. 5, step 7; FIG. 6, step 6) to start transmitting GC data for the GC service also on the second MBMS bearer in the second MBSFN area based on changes in the quality of the first MBMS bearer and, optionally, the second MBMS bearer over time.
25. The method of any one of embodiments 19 to 24 wherein sending (FIG. 5, step 8; FIG. 6, step 7) the message that indicates that GC service data for the GC service is also being transmitted on the second MBMS bearer in the second MBSFN area comprises sending (FIG. 5, step 8), to the wireless device, a message (e.g., a MapGroupToBearer message) that indicates that the GC data for the GC service is also mapped to the second MBMS bearer in the second MBSFN area.
26. The method of any one of embodiment 16 to 18 wherein the second MBMS bearer in the second MBSFN transmits the same GC data for a GC service as the first MBMS bearer in the first MBSFN (e.g., same TMGIs).
27. The method of embodiment 26 wherein proactively deciding (FIG. 5, step 7; FIG. 6, step 6) to start transmitting GC data for the GC service also on the second MBMS bearer in the second MBSFN area comprises dynamically establishing the second MBMS bearer in the second MBSFN area.
28. The method of embodiment 26 or 27 wherein sending (FIG. 5, step 8; FIG. 6, step 7) the message that indicates that GC service data for the GC service is also being transmitted on the second MBMS bearer in the second MBSFN area comprises sending (FIG. 6, step 7), to the wireless device, a MBMS bearer announcement message that indicates that the GC data for the GC service is also transmitted on the second MBMS bearer in the second MBSFN area.
29. The method of any one of embodiments 16 to 28 further comprising:

receiving (FIG. 5, step 13; FIG. 6, step 13), from the wireless device, information that indicates that a quality degradation for both the first MBMS bearer and the second MBMS bearer; and sending (FIG. 5, step 15; FIG. 6, step 15) GC data for the GC service to the wireless device over a unicast bearer.
30. A method performed by node to implement a Group Communication, GC, service server (e.g., a Mission Critical (MC) service server such as, e.g., MC Push-to-Talk (MCPTT) service server), the method comprising:

receiving (FIG. 5, step 6 or 12; FIG. 6, step 5 or 13), from a wireless device, a multi-level bearer quality indicator for a first Multicast-Broadcast Multimedia Service, MBMS, bearer in a first Multicast-Broadcast Single Frequency Network, MBSFN, area, wherein GC data for a GC service is transmitted on the first MBMS bearer in the first MBSFN area; and

making a decision based on the multi-level bearer quality indictor.
31. The method of embodiment 30 wherein making the decision based on the multi-level bearer quality indicator comprises deciding (FIG. 5, step 7 or 13; FIG. 6, step 6 or 14), based on the multi-level bearer quality indicator, whether to:

proactively establish a new GC session via an already established second MBMS bearer in a second MBSFN area over which to also transmit the GC data for the GC service;

proactively establish a new MBMS bearer in the second MBSFN over which to also transmit the GC data for the GC service, or

proactively establish a unicast bearer over which to transmit the GC data for the GC service to the wireless device.
32. The method of embodiment 30 wherein making the decision based on the multi-level bearer quality indicator comprises deciding (FIG. 5, step 7 or 13; FIG. 6, step 6 or 14), based on the multi-level bearer quality indicator, whether to proactively establish a new GC session via an already established second MBMS bearer in a second MBSFN area over which to also transmit the GC data for the GC service.
33. The method of embodiment 30 wherein making the decision based on the multi-level bearer quality indicator comprises deciding (FIG. 5, step 7 or 13; FIG. 6, step 6 or 14), based on the multi-level bearer quality indicator, whether to proactively establish a new MBMS bearer in the second MBSFN over which to also transmit the GC data for the GC service.
34. The method of embodiment 30 wherein making the decision based on the multi-level bearer quality indicator comprises deciding (FIG. 5, step 7 or 13; FIG. 6, step 6 or 14), based on the multi-level bearer quality indicator, whether to proactively establish a unicast bearer over which to transmit the GC data for the GC service to the wireless device.
35. The method of any one of embodiments 30 to 34 wherein making the decision comprises making the decision based on the based on the multi-level bearer quality indictor and one or more additional multi-level bearer quality indicators reported by the wireless device for a second MBMS bearer in the second MBSFN areas.
36. A node adapted to perform the method of any one of embodiments 16 to 35.
37. A node comprising:

a network interface; and

processing circuitry associated with the network interface, the processing circuitry configured to cause the node to perform the method of any one of embodiments 16 to 35.

1. A method performed by a wireless device comprising a Mission Critical, MC, service client to enable reception of transmissions for a MC service, the method comprises the steps of:
receiving MC service media for a MC service over a first Multicast-Broadcast Multimedia Service, MBMS, bearer identified by a first Temporary Mobile Group Identity, TMGI, (TMGI 1), while the wireless device is located in a first Multicast-Broadcast Single Frequency Network, MBSFN, area (MBSFN 1);
sending to a MC service server a first MBMS listening status report notifying the MC service server that the MC service media is successfully received over the first MBMS bearer, and including a first MBMS bearer quality indicator that indicates a reception quality level related to the first MBMS bearer;
sending a location information report to the MC service server indicating that the wireless device is now located in an overlapping area between the first MBSFN area and a second MBSFN area (MBSFN 2), in which overlapping area both the first MBMS bearer and a second MBMS bearer identified by a second TMGI (TMGI 2) are active;
receiving a MBMS bearer announcement with information relating to the second MBMS bearer indicating to the wireless device that the first MBMS bearer and the second MBMS bearer transmit the same MC service media; and
sending to the MC service server a second MBMS listening status report notifying the MC service server that MC service media can be successfully received over the first MBMS bearer and the second MBMS bearer, and including a second MBMS bearer quality indicator that indicates a reception quality level related to the first MBMS bearer and a reception quality level related to the second MBMS bearer.

2. The method of claim 1 wherein at least one of; the first MBMS bearer quality indicator is a multi-level bearer quality indicator, and/or the second MBMS bearer quality indicator is a multi-level bearer quality indicator.

3. The method of claim 1, wherein the second MBMS bearer in the second MBSFN is a different MBMS bearer than the first MBMS bearer in the first MBSFN.

4. The method of claim 1 wherein, after receiving the MBMS bearer announcement message that indicates that the MC service media is also transmitted on the second MBMS bearer in the second MBSFN area, receiving MC service media over both the first MBMS bearer and the second MBMS bearer.

5. The method of claim 4 further comprising at least one of; verifying that the same MC service media is sent on both MBMS bearers, and/or using the duplicated MC service media to perform error corrections.

6. (canceled)

7. A wireless device comprising:
one or more transmitters;
one or more receivers; and
processing circuitry associated with the one or more transmitters and the one or more receivers, the processing circuitry configured to cause the wireless device to:
receive Mission Critical, MC, service media for a MC service over a first Multicast-Broadcast Multimedia Service, MBMS, bearer identified by a first Temporary Mobile Group Identity, TMGI, (TMGI 1), while the wireless device is located in a first Multicast-Broadcast Single Frequency Network, MBSFN, area (MBSFN 1);
send to a MC service server a first MBMS listening status report notifying the MC service server that the MC service media is successfully received over the first MBMS bearer, and including a first MBMS bearer quality indicator that indicates a reception quality level related to the first MBMS bearer;
send a location information report to the MC service server indicating that the wireless device is now located in an overlapping area between the first MBSFN area and a second MBSFN area (MBSFN 2), in which overlapping area both the first MBMS bearer and a second MBMS bearer identified by a second TMGI (TMGI 2) are active;
receive a MBMS bearer announcement with information relating to the second MBMS bearer indicating to the wireless device that the first MBMS bearer and the second MBMS bearer transmit the same MC service media; and
send to the MC service server a second MBMS listening status report notifying the MC service server that MC service media can be successfully received over the first MBMS bearer and the second MBMS bearer, and including a second MBMS bearer quality indicator that indicates a reception quality level related to the first MBMS bearer and a reception quality level related to the second MBMS bearer.

8. A method performed by node to implement a Mission Critical (MC) service server, the method comprises the steps of:
receiving from a wireless device while it is located in a first Multicast-Broadcast Single Frequency Network, MBSFN, area (MBSFN 1), a first MBMS listening status report notifying the MC service server that MC service media is successfully received over a first MBMS bearer identified by a first Temporary Mobile Group Identity, TMGI, (TMGI 1), and including a first MBMS bearer quality indicator that indicates a reception quality level related to the first MBMS bearer;
receiving from the wireless device, a location information report indicating that the wireless device is now located in an overlapping area between the first MBSFN area and a second MBSFN area (MBSFN 2), in which overlapping area both the first MBMS bearer and a second MBMS bearer identified by a second TMGI (TMGI 2) are active;
sending to the wireless device, a MBMS bearer announcement with information relating to the second MBMS bearer indicating to the wireless device that the first MBMS bearer and the second MBMS bearer transmit the same MC service media; and
receiving from the wireless device, a second MBMS listening status report notifying the MC service server that MC service media can be successfully received over the first MBMS bearer and the second MBMS bearer, and including a second MBMS bearer quality indicator that indicates a reception quality level related to the first MBMS bearer and a reception quality level related to the second MBMS bearer.

9. The method of claim 8 wherein at least one of; the first MBMS bearer quality indicator is a multi-level bearer quality indicator, and/or the second MBMS bearer quality indicator is a multi-level bearer quality indicator.

10. The method of claim 8, wherein the second MBMS bearer in the second MBSFN is a different MBMS bearer than the first MBMS bearer in the first MBSFN.

11. The method of claim 8 wherein, after receiving the MBMS bearer announcement message that indicates that the MC service media is also transmitted on the second MBMS bearer in the second MBSFN area, receiving MC service media over both the first MBMS bearer and the second MBMS bearer.

12. The method of claim 11 further comprising at least one of; verifying that the same MC service media is sent on both MBMS bearers, and/or using the duplicated MC service media to perform error corrections.

13. (canceled)

14. A node comprising:
a network interface; and
processing circuitry associated with the network interface, the processing circuitry configured to cause the node to:
receive from a wireless device while it is located in a first Multicast-Broadcast Single Frequency Network, MBSFN, area (MBSFN 1), a first MBMS listening status report notifying the Mission Critical, MC, service server that MC service media is successfully received over a first MBMS bearer identified by a first Temporary Mobile Group Identity, TMGI, (TMGI 1), and including a first MBMS bearer quality indicator that indicates a reception quality level related to the first MBMS bearer;
receive from the wireless device, a location information report indicating that the wireless device is now located in an overlapping area between the first MBSFN area and a second MBSFN area (MBSFN 2), in which overlapping area both the first MBMS bearer and a second MBMS bearer identified by a second TMGI (TMGI 2) are active;
send to the wireless device, a MBMS bearer announcement with information relating to the second MBMS bearer indicating to the wireless device that the first MBMS bearer and the second MBMS bearer transmit the same MC service media; and
receive from the wireless device, a second MBMS listening status report notifying the MC service server that MC service media can be successfully received over the first MBMS bearer and the second MBMS bearer, and including a second MBMS bearer quality indicator that indicates a reception quality level related to the first MBMS bearer and a reception quality level related to the second MBMS bearer.
